(19) United States
(12) Patent Application Publication
(10) Pub. No.: US 2011/0181878 A1
(43) Pub. Date: Jul. 28, 2011

(54) Method and System for Raman Detection

(75) Inventors: Shaw-Hwa PARNG, Kaohsiung County (TW); Philip-Leslie DRAKE, Taipei City (TW)

(73) Assignee: INDUSTRIAL TECHNOLOGY RESEARCH INSTITUTE, Hsinchu (TW)

(21) Appl. No.: 12/835,715

(22) Filed: Jul. 13, 2010

(30) Foreign Application Priority Data
Jan. 26, 2010 (TW) TW99102051

(51) Int. Cl. G01J 3/44

(52) U.S. Cl. 356/301

(57) ABSTRACT

A method and a system for Raman detection are provided. Embodiments of the method include providing a fluid analyte at a signal-enhancing structure including a V-groove for Raman signal enhancement of the analyte. The invention further provides a Raman detection system which includes the above signal-enhancing structure and a Raman spectrometer.

### CROSS REFERENCE TO RELATED APPLICATIONS

This application claims priority of Taiwan Patent Application No. 099102051, filed on Jan. 26, 2010, the entirety of which is incorporated by reference herein.

### TECHNOLOGY FIELD

The disclosure relates to Raman spectroscopy, and in particular, relates to a Raman detection method and system using a signal-enhancing structure for analyzing a fluid analyte of interest.

### BACKGROUND

Raman spectroscopy is based on the detection of scattered light, characterized by its applicability to samples of various forms (e.g., solids, powders, liquids, and gases) and special advantages of not requiring sample preparation and having a non-destructive nature. However, Raman signals can be very weak, making detection difficult. Surface enhanced Raman spectroscopy is a known technique for increasing Raman signal emissions. In particular, a microstructured metal surface and nanoparticles are two useful tools for Raman signal enhancement. Regarding the design of a microstructured metal surface, a study on the influence of hollow cylinder sizes on Raman signals indicated that a smaller size results in higher intensity of Raman signals. Regarding the use of nanoparticles, it is known that the enhancement mechanism is associated with the surface characteristics and the spacing of nanoparticles. For example, U.S. Pat. No. 7,443,489 discloses a composite nanoparticle combining a surface-enhanced spectroscopy-active metal nanoparticle with a spectroscopy-active tag. In addition, nanotubes, nanodisc arrays, nanoburgers, triangular nanoprisms, nanoantennas, nanopins, and so on have been studied for enhancing Raman signals.

### SUMMARY

One embodiment of the invention provides a method for detection of a fluid analyte. An exemplary method includes the steps of: providing the fluid analyte on a signal-enhancing structure, wherein the signal-enhancing structure comprises a substrate and at least one V-groove in the substrate for Raman signal enhancement; irradiating the fluid analyte on the signal-enhancing structure with laser radiation to produce a surface-enhanced Raman signal; and detecting the surface-enhanced Raman signals from the fluid analyte by a Raman spectrometer.

Another embodiment of the invention provides a system for Raman spectroscopy. An exemplary system includes a signal-enhancing structure, wherein the signal-enhancing structure comprises a substrate and at least one V-groove in the substrate for Raman signal enhancement; and a Raman spectrometer for detecting a surface-enhanced Raman signal from the signal-enhancing structure.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1a is a schematic view showing a Raman detection system according to an embodiment of the invention; and

FIGS. 1b-1e are cross sectional views showing signal-enhancing structures according embodiments of the invention;

FIGS. 2a-2b are cross sectional views showing the enhanced mechanisms of Raman signal for the fluid analyte on V-groove and rectangle profiles, respectively;

FIGS. 3a-3c are plots showing the intensity of Raman signals of different groove profiles;

FIG. 4 are plots showing the intensity of Raman signals of different V-groove depths;

FIG. 5 is a plot showing the intensity of Raman signals on different positions of a V-groove with a flat bottom;

FIG. 6 is a plot showing the intensity of Raman signals of a V-groove array and a single V-groove; and

FIG. 7 is a plot showing the intensity of Raman signals on different positions of a V-groove array.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The disclosure provides a Raman signal amplification technique by employing a V-groove structure having slant sidewalls. The V-groove structure effectively enhances a Raman signal produced from testing samples or species, thereby providing enhanced sensitivity of Raman detection.

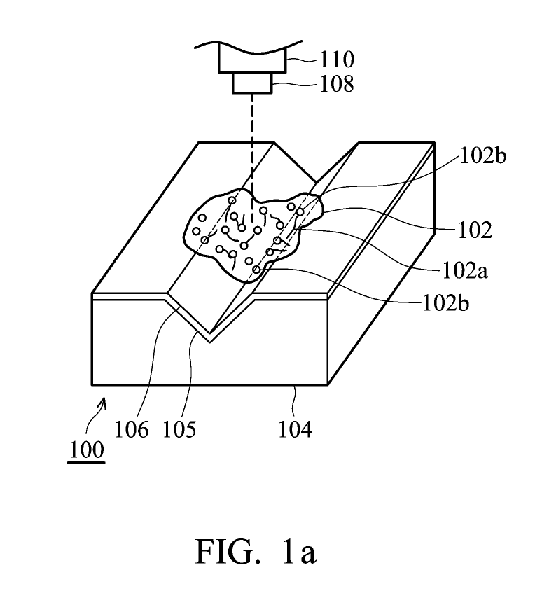

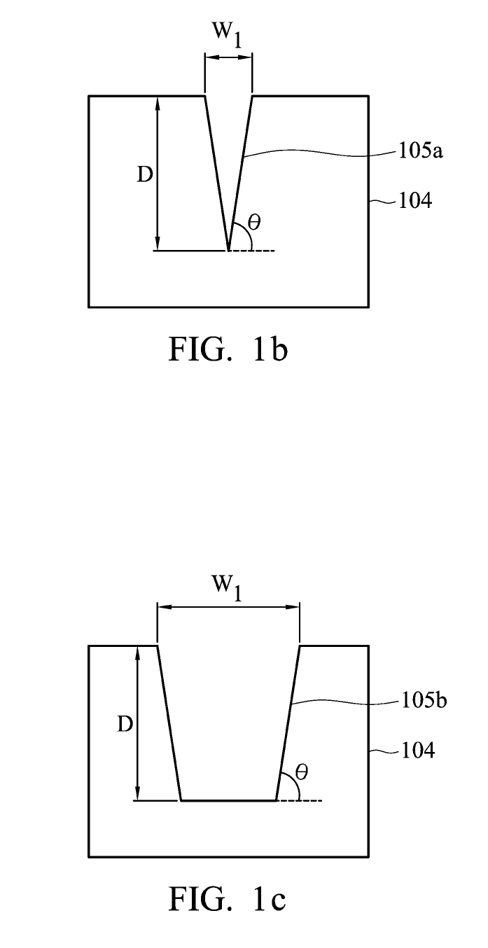

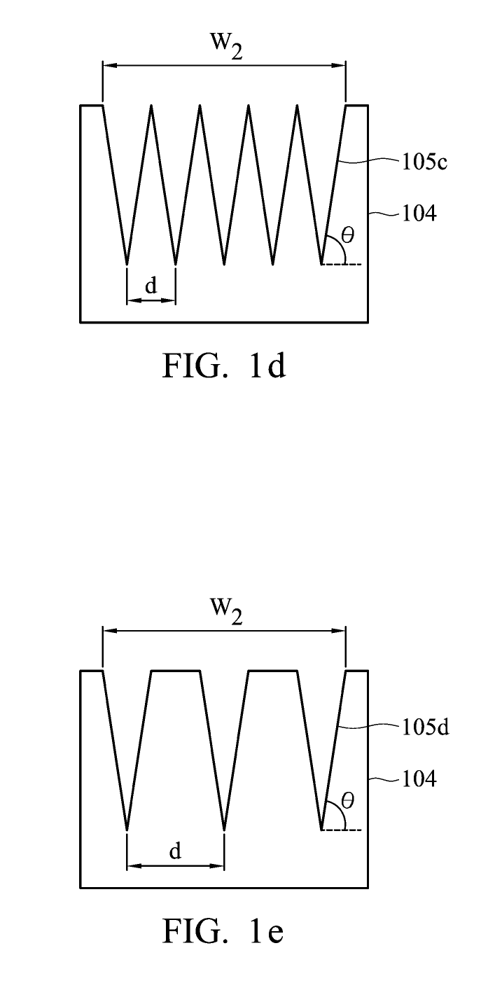

FIG. 1a is a schematic view showing a Raman detection system according to an embodiment of the invention, which includes a Raman spectrometer 110 and a signal-enhancing structure 100. A typical Raman spectrometer is composed of a light source, a monochromator, a sample carrier, a fixation device for a detection point, a charge-coupled device (CCD), a light amplifier, an electronic signal processor, and so on. Since these features of the Raman spectrometer are well known, only a laser light source 108 is shown in the drawing for the sake of clarity.

As shown in FIG. 1a, the signal-enhancing structure 100 includes at least one V-groove 105 in a substrate 104 as a microfluidic channel. The substrate 104 can be formed of materials made of polymers, semiconductors, metals, ceramics, and so on. The V-groove 105 can be formed by photolithography and etching processes, or alternatively by a mechanical processing. The surface of the V-groove 105 is covered by a metal layer 106, for example, by plasma sputtering. The metal layer may be formed of highly conductive materials such as gold, silver, or platinum.

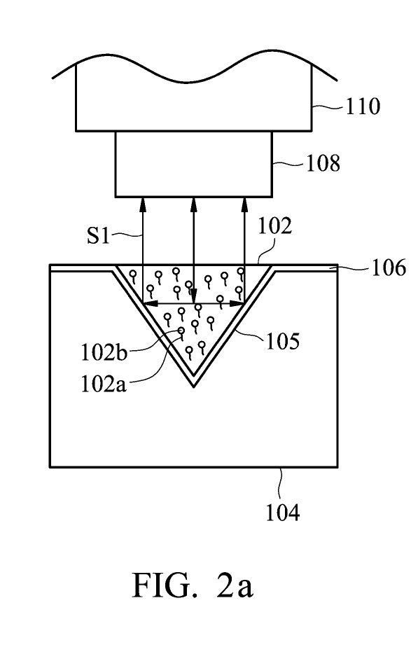

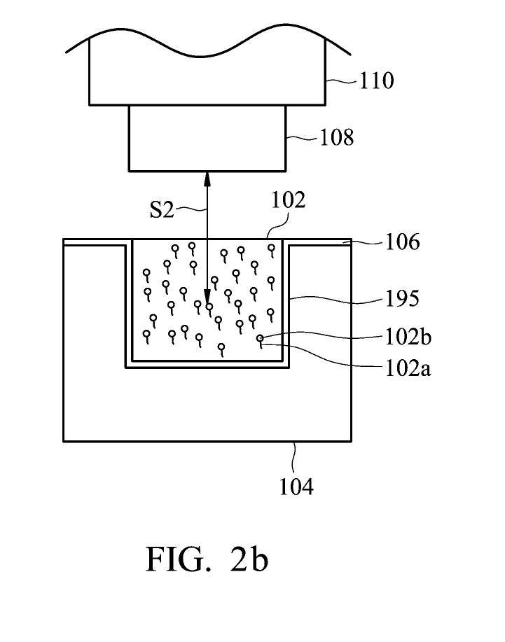

As shown in FIG. 2a, the slanted sidewalls of the V-groove 105 allow multiple reflections of Raman signals S1 between the opposite sidewalls and thereby increase the intensity of the signals S1 detected by a Raman spectrometer 110. On the other hand, it is apparent from FIG. 2b that a rectangular groove 195 cannot induce multiple reflections due to lack of slanted sidewalls. As such, the intensity of the detected signal S2 is much lower.

Referring back to FIG. 1a, the detection method of the invention includes providing a fluid analyte 102 on the signal-enhancing structure 100, and irradiating the fluid analyte 102 on the signal-enhancing structure 100 with laser radiation to produce a surface-enhanced Raman signal. The fluid analyte 102 may be a solution containing a testing sample 102a and metallic nanoparticles 102b, wherein the metallic nanoparticles 102b can be coupled to the testing sample 102a by chemical bonds for Raman signal enhancement. The testing sample 102a may be a specimen or synthetic molecule, including, but not limited to, nucleic acids, substrates, enzymes, coenzymes, complements, antigen, proteins, nucleoprotein, lipids, synthetic beads, cells, and other types of bio-molecules.

Besides the V-groove profile as illustrated in FIG. 1a, the signal-enhancing structure of the invention may have many variations. Some of specific embodiments are illustrated in FIGS. 1b-1e. FIG. 1b shows a signal enhancing structure similar to that of FIG. 1a, which is a single V-groove 105a with a pointed bottom. FIG. 1c shows a signal enhancing structure composed of a single V-groove 105b with a flat bottom. The signal enhancing structures of FIGS. 1d-1e are V-groove arrays 105c, 105d composed of a plurality of V-grooves periodically arranged in the substrate 104, wherein each top corner of the V-grooves is level with the top surface of the substrate 104. FIG. 1d shows a V-groove array 105c composed of continuous V-grooves, wherein any two adjacent V-grooves are joined to each other, thus forming a sawtooth structure. On the other hand, FIG. 1e shows a V-groove array 105d composed of a plurality of V-grooves spaced apart from each other. Although not shown in the figures, those skilled in the art will appreciate that a V-groove array composed of V-grooves with a flat bottom or non-periodically arranged V-grooves may be utilized to achieve signal enhancement. According to the invention, the V-groove may have a tilt angle of about 10° to 88°, preferably about 45° to 88° with respect to a horizontal plane. The depth D of the V-groove may range from about 1 μm to about 300 μm, and the width W₁ of a single V-groove may range from about 1 μm to about 3000 μm.

The pitch of the V-grooves of the array in FIGS. 1c-1d may range from about 1 μm to about 3000 μm. It should be noted that, the laser radiation produced by the light source 18, preferably has a diameter larger than a total width W₂ of the V-groove array 105c, 105d such that all of the V-grooves in the array can contribute to signal enhancement. The number of V-grooves in the array is not particularly limited. In a given total width W₂, one can increase the tilt angle of the groove to maximize the number of the grooves. However, the width W₁ of a single groove should not be smaller than the wavelength of the light source, otherwise the light source would not be able to enter into the V-groove. For example, when a laser beam having a wavelength of 670 nm is employed, the width of a single groove should be not less than 670 nm.

In addition to the aforementioned V-grooves, other features having a slant sidewall may be employed for Raman signal enhancement. For example, pyramid arrays, triangular pyramid arrays, hexagonal pyramid arrays, polygonal pyramid arrays, polygonal prism arrays, conical arrays, concentric conical arrays, and irregular prism arrays can be employed in a microfluidic channel for signal enhancement.

Accordingly, the invention provides a microfluidic channel having a V-groove profile to achieve amplification of Raman signals. The slanted sidewalls of the V-groove allow multiple reflections of Raman signals to increase signal intensity. The effectiveness of signal amplification of a V-groove is verified by the following working examples.

### EXAMPLE 1

In this example, the influence of groove profiles on Raman intensity was evaluated. Microfluidic channels having V-shaped, rectangular, and semicircular cross-sectional profiles were fabricated on polymethylmethacrylate (PMMA) substrates by precision machining. Each of the microfluidic channels had the same depth of 0.5 mm and the same length of 44 mm, with a single inlet and exit. The channels having rectangular and semicircular profiles had a width of 1 mm, and the channel having a V-shaped profile had a tilt angle of 30 degrees. A 1 mm-thick cover plate made of polydimethysiloxane (PDMS) was used to cover the channels.

A testing solution containing colloidal gold nanoparticle (diameter: 30 nm) with a concentration of 176 pM was prepared, which exhibited Raman peaks at 1075 cm⁻¹ (corresponding to ring-breathing modes; υ(CC)_{ring}) and 1585 cm⁻¹ (corresponding to ring-stretching modes; υ(CC)_{ring}). Raman spectroscopy was measured by a portable Raman spectrometer, EZRaman-L (from Enwave Optronics Inc., Irvine, Calif.) using a 670 nm laser beam with an output power of 200 mW.

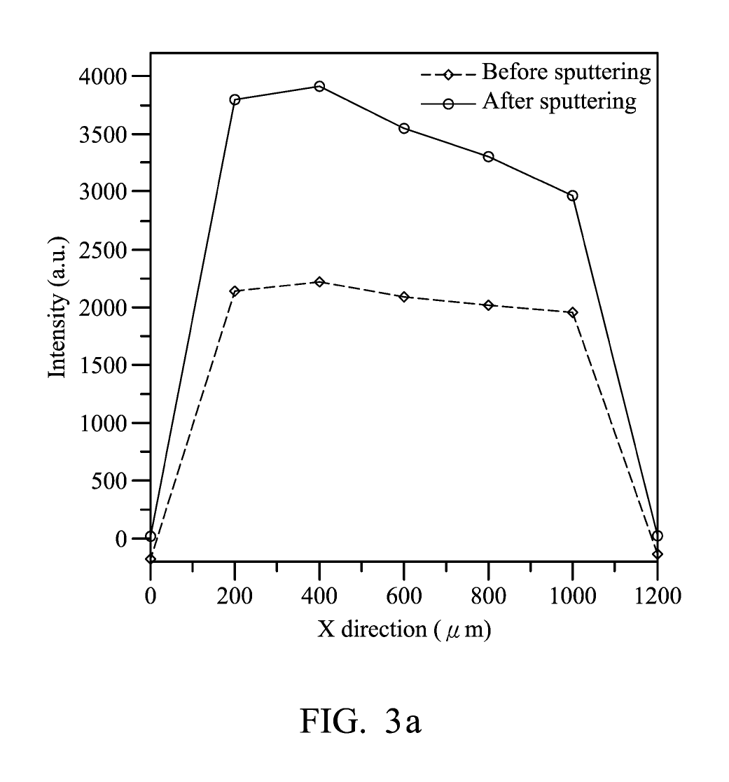

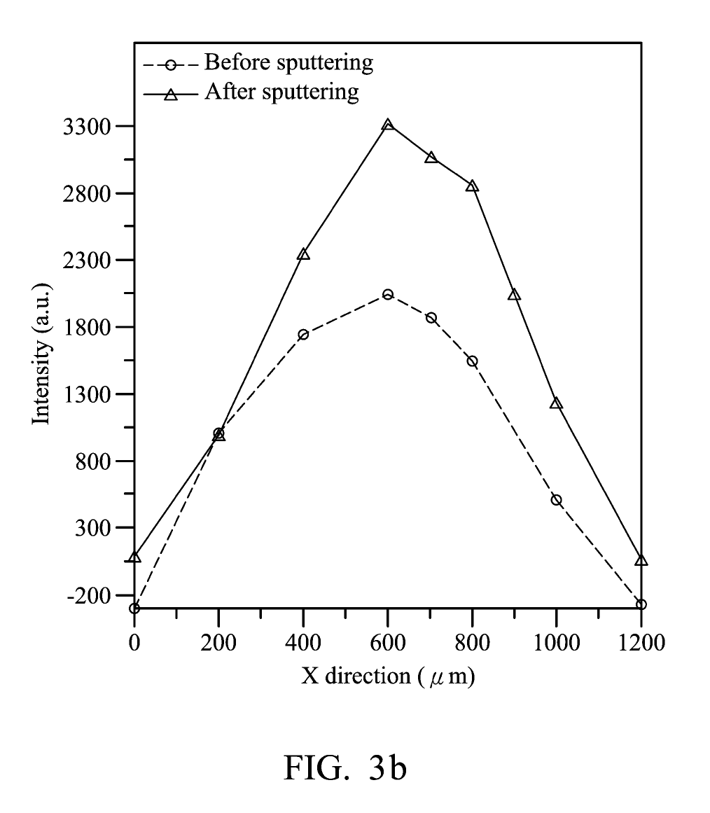

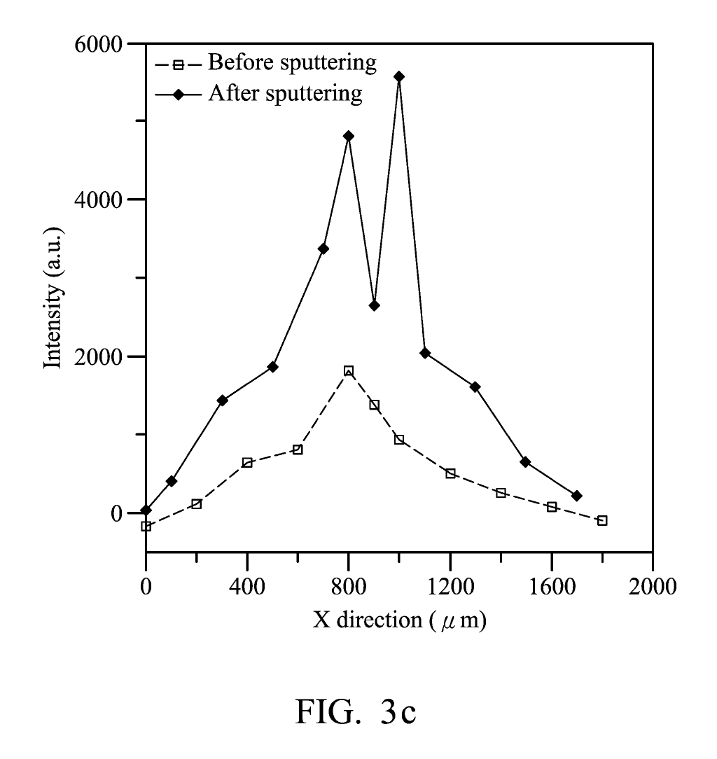

FIGS. 3a-3c are plots showing the intensity of Raman signals of rectangular (3a), semicircular (3b), and V-shaped (3c) profiles, before and after sputtering of a platinum coating. As shown in the figures, before sputtering, all of the three groove profiles exhibited similar signal intensities with the maximum at the center of the cross section. After sputtering of a 1000 Å-thick platinum coating, all Raman signals were amplified, among which, the V-groove exhibited a significantly higher amplification, wherein the maximum intensity was amplified about three-fold.

To detect Raman signals of different positions of the V-groove, the substrate with the V-groove was disposed on a platform capable of lateral movement, equipped with a Raman signal detector. The platform laterally moved by 200 μm intervals to detect the signal of the colloidal gold nanoparticles.

As shown in FIG. 3C, the signal intensity had a positive correlation with the depth of the cross section. Namely, the deeper the depth, the stronger the Raman intensity, either before or after sputtering. A relative low intensity at the center of the V-groove can be attributed to a flat bottom caused by the tip of the cutting tool. Accordingly, it can be seen that the signal intensities on a flat surface and slant sidewalls were greatly different.

As mentioned earlier, when laser radiation fell on the slanted sidewalls of the V-groove, the detection area was increased by multiple reflections of the signals between opposite sidewalls, thereby increasing intensity thereof.

### EXAMPLE 2

A signal-enhancing structure containing a V-groove formed by wet etching was prepared. A silicon nitride layer with a thickness of 700 nm was deposited on opposite surfaces of a 4-inch silicon wafer by low pressure chemical vapor deposition. The silicon nitride layer was patterned by photolithography using a photoresist layer and reactive ion etching (RIE). Then the silicon substrate was etched by KOH to form a V-groove. The photoresist layer and the silicon nitride layer were removed by acetone and hydrofluoric acid, respectively. Thereafter, a composite coating of Cr/Au (20/200 nm) was formed on the wafer surface by sputtering. The V-groove was filled with the same testing solution as in Example 1 and capped by a sealant with a thickness of 50 μm.

The signal-enhancing structure thus obtained was a V-groove having a flat bottom and a top width of 3 mm. Both sidewalls of the V-groove had a tilt angle of 54.7° due to the anisotropic nature of the etching behavior.

### EXAMPLE 3

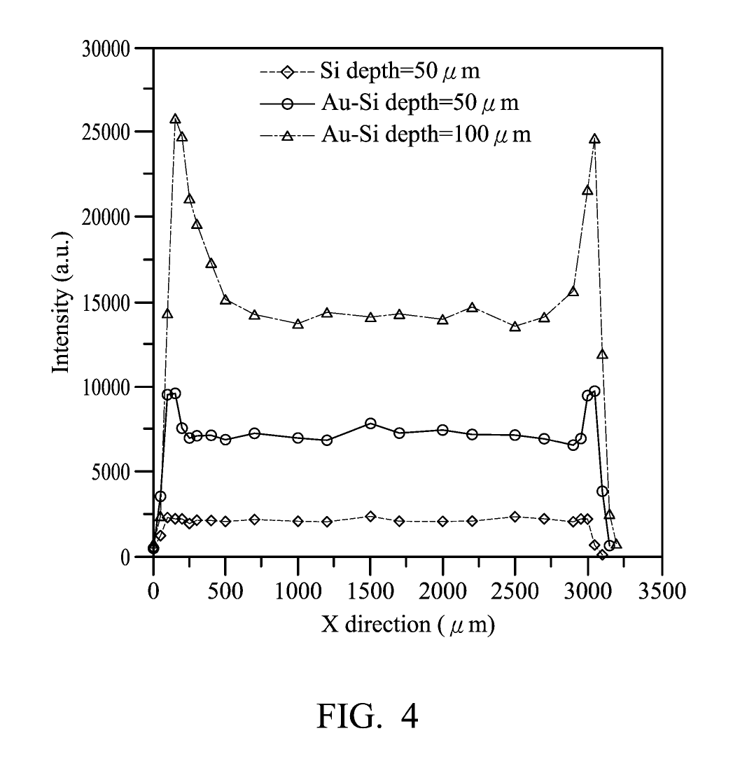

In this example, the influence of groove depths on the Raman signal enhancement was evaluated using a V-groove having a flat bottom and a top width of 3 mm. The Raman signals at 1585 cm⁻¹ along different lateral positions in the V-groove profile were measured. FIG. 4 shows that under the same groove depth (50 μm), the Raman intensity was increased by 3.3 times after sputtering of gold (Au). Significant amplification was observed at the junction between the flat bottom and the slanted sidewalls, and the amplification was positively correlated with the groove depth. As shown in FIG. 4, the Raman intensity at the flat bottom was increased twice when the groove depth was increased from 50 μm to 100 μm. Furthermore, the deeper groove also exhibited a higher amplification level at the junction between the flat bottom and the slanted sidewalls. For the deeper groove, the Raman intensity at the junction position (25200) was 76% higher that at the flat bottom (14300). However, for the shallower groove, the Raman intensity at the junction position (9600) was only 35% higher than that at the flat bottom (7100).

### EXAMPLE 4

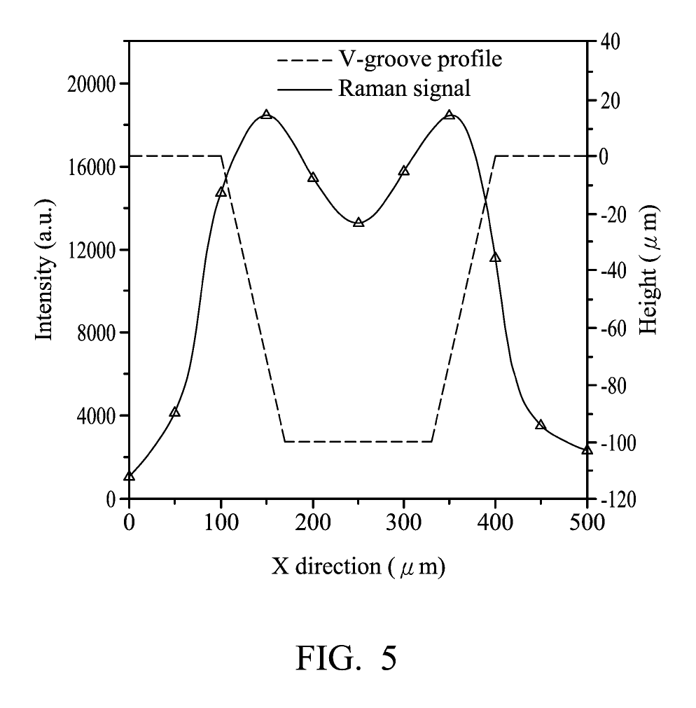

In this example, the signal enhancement at the junction position was evaluated using a gold-coated V-groove having a flat bottom (top width: 300 μm, depth: 100 μm, bottom width: 158 μm). FIG. 5 shows the Raman signals at 1585 cm⁻¹ along different lateral positions in the V-groove profile, where the groove profile is also indicated by dashed lines. The Raman signals increased with the depth of the V-groove, and significant amplification was observed at the junction between the flat bottom and the slanted sidewalls. The local amplification can be attributed to the significant change of surface geometry at the junction position, provided that the nanoparticles were evenly distributed over the V-groove. This change of surface geometry may result in a violent reflection of light path, thereby locally increasing the Raman intensity. In FIG. 5, the Raman intensity at the junction position (18500) was 39% higher than that at the flat bottom (13300), and the distribution of signal intensity was symmetrical with respect to the axis of the symmetric V-groove. At the flat bottom of the V-groove, since the diameter of the radiation source was smaller than the width of the flat bottom, there was no reflection to increase the Raman intensity.

### EXAMPLE 5

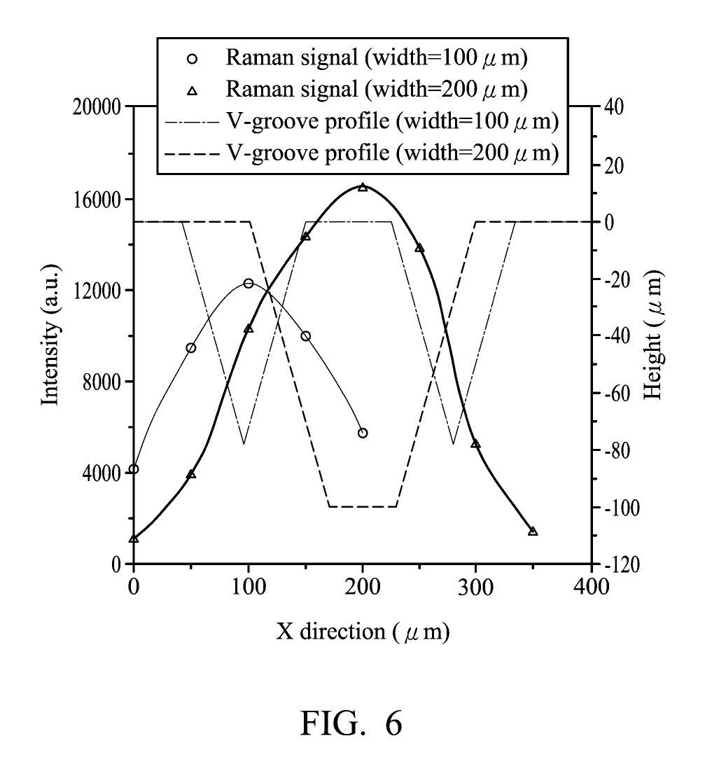

In FIG. 6, the signal enhancement of a V-groove array (top width: 100 μm, depth: 78 μm for each V-groove) and a single V-groove having a flat bottom (top width: 200 μm, depth: 100 μm, bottom width: 58 μm) was compared. A maximum Raman intensity for the V-groove array was obtained when the laser radiation was focused on the tip of the V-groove. However, the intensity gradually decreased to 4000 when the focus of the laser radiation moved to a flat substrate surface adjacent to the groove. Therefore, it can be ascertained that the diameter of the laser radiation was greater than the width of the V-groove.

In the case of the single V-groove, the Raman signal increased with the depth of the V-groove. However, in this example, the maximum intensity was observed at the flat bottom. That is, no local amplification was observed at the junction between the flat bottom and the slanted sidewalls. This was because the diameter of the laser radiation (about 150 μm) was greater than the bottom width (58 μm) of the V-groove, making local amplification insignificant. As also can be seen in FIG. 6, signal amplification was positively correlated with the groove depth. When the groove depth increased 28% (from 78 μm to 100 μm), Raman intensity increased 35% (from 12310 to 16556).

### EXAMPLE 6

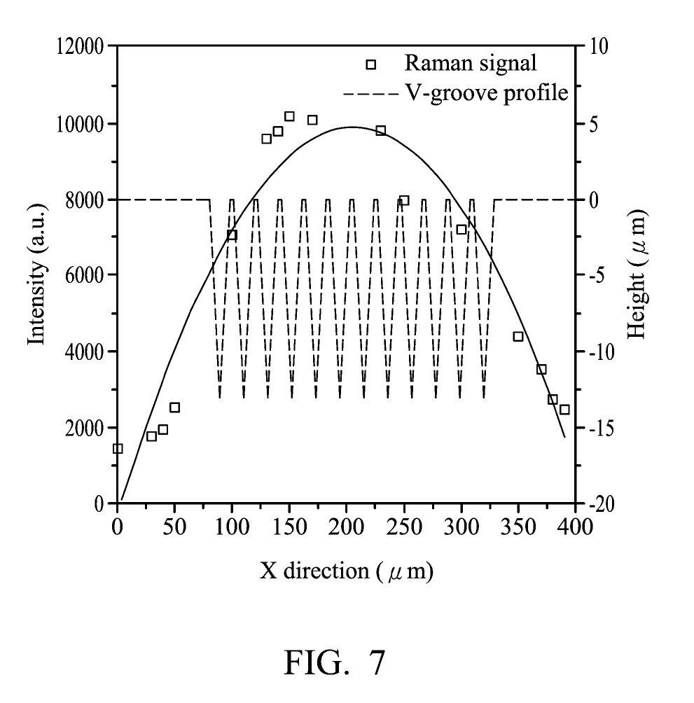

The signal enhancement of a V-groove array (top width: 18 μm, depth: 13 μm for each V-groove; total width (top): 250 μm) was evaluated. As shown in FIG. 7, a maximum intensity of 10203 was observed when laser radiation was focused on the center of the array, because at this position, the laser radiation covered the maximum numbers of V-grooves. Accordingly, it is preferable to employ a laser radiation having a diameter greater than the total width of the V-groove array to obtain the highest amplification level as possible.

According to the results of aforementioned examples, the Raman intensity was approximately proportional to the depth of a single V-groove. Therefore, in theory, the Raman intensity should decrease from 12310 to 2052 when the groove depth decreased from 78 μm to 13 μm. However, in the case of a V-groove array having a depth of 13 μm, the detected Raman intensity was 10203, being 5 times that of the theoretical value. Apparently, the sawtooth structure provided by the V-groove array is unexpectedly effective for Raman signal enhancement.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for detection of a fluid analyte, comprising the steps of:
providing the fluid analyte on a signal-enhancing structure, wherein the signal-enhancing structure comprises a substrate and at least one V-groove in the substrate for Raman signal enhancement;
irradiating the fluid analyte on the signal-enhancing structure with laser radiation to produce a surface-enhanced Raman signal; and
detecting the surface-enhanced Raman signals from the fluid analyte by a Raman spectrometer.

2. The method as claimed in claim 1, wherein the V-groove comprises a flat bottom.

3. The method as claimed in claim 1, wherein the V-groove comprises a pointed bottom.

4. The method as claimed in claim 1, wherein the V-groove has a tilt angle of between 10° and 88° with respect to a horizontal plane.

5. The method as claimed in claim 1, wherein the V-groove has a depth of between 1 μm and 300 μm.

6. The method as claimed in claim 1, wherein the V-groove has a width of between 1 μm and 3000 μm.

7. The method as claimed in claim 1, wherein the signal-enhancing structure comprises a V-groove array including a plurality of V grooves.

8. The method as claimed in claim 7, wherein the V-grooves in the V-groove array have a pitch of between 1 μm and 3000 μm.

9. The method as claimed in claim 7, wherein each top corner of the V-grooves is level with a top surface of the substrate.

10. The method as claimed in claim 7, wherein the laser radiation has a diameter larger than a width of the V-groove array.

11. A system for Raman spectroscopy, comprising:
a signal-enhancing structure, wherein the signal-enhancing structure comprises a substrate and at least one V-groove in the substrate for Raman signal enhancement; and
a Raman spectrometer for detecting a surface-enhanced Raman signal from the signal-enhancing structure.

12. The system as claimed in claim 11, wherein the V-groove comprises a flat bottom.

13. The system as claimed in claim 11, wherein the V-groove comprises a pointed bottom.

14. The system as claimed in claim 11, wherein the V-groove has a tilt angle of between 10° and 88° with respect to a horizontal plane.

15. The system as claimed in claim 11, wherein the V-groove has a depth of between 1 μm and 300 μm.

16. The system as claimed in claim 11, wherein the V-groove has a width of between 1 μm and 3000 μm.

17. The system as claimed in claim 11, wherein the signal-enhancing structure comprises a V-groove array including a plurality of V grooves.

18. The system as claimed in claim 17, wherein the V-grooves in the V-groove array have a pitch of between 1 μm and 3000 μm.

19. The system as claimed in claim 17, wherein each top corner of the V-grooves is level with a top surface of the substrate.

20. The system as claimed in claim 17, wherein the laser radiation has a diameter larger than a width of the V-groove array.
